(19) United States
(12) Patent Application Publication
(10) Pub. No.: US 2003/0180186 A1
(43) Pub. Date: Sep. 25, 2003

(54) Process and device for continuous tonic monitoring of aqueous solutions

(76) Inventors: William W. Carson, Hipkinton, MA (US); Oleg Grebenyuk, Woburn, MA (US); Thomas J. Susa, Ludlow, MA (US)

Correspondence Address: David Silverstein, Andover IP Law, Suite 300, 44 Park Street, Andover, MA, 01810, US

(21) Appl. No.: 10/343,270

(22) PCT Filed: Aug. 10, 2001
(86) PCT No.: PCT/US01/25264

(51) Int. Cl. G01N 27/26

(52) U.S. Cl. 422/82.02; 422/82.01

(57) ABSTRACT

An electrolytic process and apparatus are disclosed for continuously producing the cation conductivity, anion conductivity, and temperature data required for continuous monitoring of the pH of high-purity aqueous solution flows. The cation exchange material and the anion exchange material used for conditioning water samples for conductivity measurements are continuously regenerated by applying a DC electric voltage between an anode and a cathode either across the cation exchange material, whereby hydrogen ions generated at the anode move through the cation exchange material displacing cations previously absorbed and these displaced cations under the influence of the electric field migrate to the cathode, or across the anion exchange material, whereby hydroxyl ions generated at the cathode regenerate the anion exchange material. The temperature-corrected cation conductivity and the temperature-corrected anion conductivity are then used together with measurement of the specific conductivity of the sample to calculate the pH of the sample.

### FIELD OF THE INVENTION

The present invention relates to the measurement of the conductivity of ionic species in water and to enhanced conductivity measurements of “cation conductivity” and “anion conductivity.” The term “cation conductivity” is defined as the conductivity of a sample in which essentially all of the cations in the sample have been replaced with hydrogen ions. The term “anion conductivity” is defined as the conductivity of a sample in which essentially all of the anions in the sample have been replaced with hydroxyl ions. With temperature-corrected measurements of the specific conductivity, cation conductivity, and anion conductivity of a sample, the pH of high purity water can be accurately calculated.

### BACKGROUND OF THE INVENTION

Conventional methods for conditioning water for the measurement of cation the original salts present in the sample. These bases have a higher conductivity than the conductivity of the sample with the original salts.

The cation conductivity and the anion conductivity are important measurements because they give an indication of the ionic purity of the water being tested. In modern electric power generating plants, the water flowing into high pressure steam boilers must be continuously monitored for ionic purity and treated to prevent corrosion of the boiler tube walls, the steam turbines, and the condensers. Sample streams from various parts of the system must be monitored for specific conductivity and cation conductivity. The length of time that a stream can be monitored for cation conductivity is dependent on the size of the cation exchange column being used to treat samples or a sample stream, the sample stream flow rate, and the number of cations present in the water. A larger volume cation exchange column, with the sample stream flowing at the same rate, would have to be replaced and regenerated with acid less frequently; but, as the size of the cation exchange column increases, the time delay of the measurement increases. Of course, if the sample stream flow rate is increased to decrease the time delay of the measurement, the frequency of the need for column replacement or regeneration again increases.

Most, if not all, of the above limitations and deficiencies of conventional apparatus and processes for ionic monitoring of aqueous solutions are either overcome or at least significantly improved upon by the improved process and device for continuous ionic monitoring of aqueous solutions according to the present invention. Other objects and advantages of the present invention will in part be obvious and will in part appear hereinafter. The invention accordingly comprises, but is not limited to, the apparatus and related methods, involving the several steps and the various components, and the relation and order of one or more such steps and components with respect to each of the others, as exemplified by the following description and the accompanying drawings. Various modifications of and variations on the apparatus and methods as herein described will be apparent to those skilled in the art, and all such modifications and variations are considered within the scope of the invention. In particular, the present invention provides the desired fast response time while eliminating the cost and complexity of conventional ion exchange columns heretofore used for this purpose.

### SUMMARY OF THE INVENTION

The present invention relates to aqueous stream monitoring using a continuous electrochemical regeneration of ion exchange material. Cation conductivity measurements are taken using a conventional conductivity cell, together with well-known temperature correction techniques, on a sample stream that has been passed through or otherwise in contact with a cation exchange material which absorbs essentially all of the cations in the stream and replaces them with hydrogen ions. In accordance with the present invention, this cation exchange material is continuously regenerated by the passage of hydrogen ions which are produced in an adjacent source of such hydrogen ions, such as an anode compartment which is separated from the cation exchange material by a cation exchange membrane, or a bipolar membrane which is in contact with a portion of the cation exchange material. In accordance with the present invention, another portion of the cation exchange material is maintained in contact with a cation exchange membrane which isolates the cathode compartment to which the cations originally absorbed by the cation exchange material migrated under the influence of a DC voltage gradient.

In a like manner, anion conductivity measurements are taken using a conventional conductivity cell, together with temperature correction techniques, on a sample stream that has been passed through or otherwise in contact with an anion exchange material which absorbs essentially all of the anions in the stream and replaces them with hydroxyl ions. In accordance with the present invention, this anion exchange material is continuously regenerated by the passage of hydroxyl ions which are produced in an adjacent source of such hydroxyl ions, such as a cathode compartment which is isolated from the anion exchange material by an anion exchange membrane, or a bipolar membrane which is in contact with a portion of the anion exchange material. In accordance with the present invention, another portion of the anion exchange material is maintained in contact with an anion exchange membrane which isolates the anode compartment to which the anions originally absorbed by the anion exchange material migrated under the influence of a DC voltage gradient.

For relatively pure water that contains no “weak” or buffering ions, the temperature-corrected specific conductivity, the temperature-corrected cation conductivity and the temperature-corrected anion conductivity determined in accordance with this invention can be used in calculations to highly accurately determine the pH of the sample stream being monitored. This method of determining the pH of high purity water also has the benefits of stability, lack of drift, and lack of contamination which are problematic for conventional pH measuring devices when used for high purity water.

The present invention also contemplates the independent use of cation exchanger units as herein described for monitoring the cation conductivity of a sample, and the independent use of anion exchanger units as herein described for monitoring the anion conductivity of a sample.

### BRIEF DESCRIPTIONS OF THE DRAWINGS

FIG. 1 is a schematic cross sectional view of an ion exchange unit according to a first embodiment of the present invention wherein ion exchange material is contained between walls of ion exchange membrane which walls contain or are otherwise in contact with electrodes.

FIGS. 2A and 2B are schematic top and cross sectional views respectively of an ion exchange unit according to an alternative embodiment of the present invention wherein an ion exchange membrane is also used as the ion exchange material.

FIG. 3 is a schematic process flow diagram illustrating a continuous ionic monitoring system for aqueous solutions according to the present invention wherein two ion exchange units, comparable to those illustrated in FIG. 1 or FIGS. 2A and 2B, are utilized in a parallel configuration.

### DETAILED DESCRIPTION OF THE PREFERRED EMBODIMENTS

The present invention is based on the novel idea of performing continuous ionic monitoring of aqueous solutions by continuously regenerating ion exchange materials by means of an applied DC electrical current.

Highly accurate pH determinations for high purity water can be calculated from temperature-corrected measurements of specific conductivity, cation conductivity and anion conductivity utilizing the apparatus and methods of the present invention. In accordance with a preferred embodiment of this invention, a cation conductivity sample stream and an anion conductivity sample stream are treated and measured for conductivity. In general, in the case of the cation conductivity sample stream, after exiting the conductivity meter, part or all of the stream flows past the anode (positive) electrode, then flows by a fluid conduit means past the cathode and continues on to waste. At the anode, hydrogen ions are produced by the electrolysis of water from the previously measured sample stream, and these hydrogen ions migrate, under the influence of a DC voltage, through a cation exchange membrane, into the cation exchange material, where they regenerate the cation exchange material by displacing other cations which had been absorbed from the sample stream. These displaced cations then migrate under the influence of the DC voltage through a cation exchange membrane and to the cathode (negative) electrode and into the waste stream flowing from the anode compartment and through the cathode compartment.

Similarly, in the case of the anion conductivity sample stream, after exiting the conductivity meter, part or all of the stream flows past the cathode (negative) electrode, then flows by tubing past the anode and continues on to waste. At the cathode, hydroxyl ions are produced by the electrolysis of water, and these hydroxyl ions migrate, under the influence of a DC voltage, into the anion exchange material, where they regenerate the anion exchange material by displacing other anions which had been absorbed from the sample stream. These displaced anions then migrate under the influence of the DC voltage to the anode (positive) electrode and into the waste stream flowing from the cathode compartment and through the anode compartment.

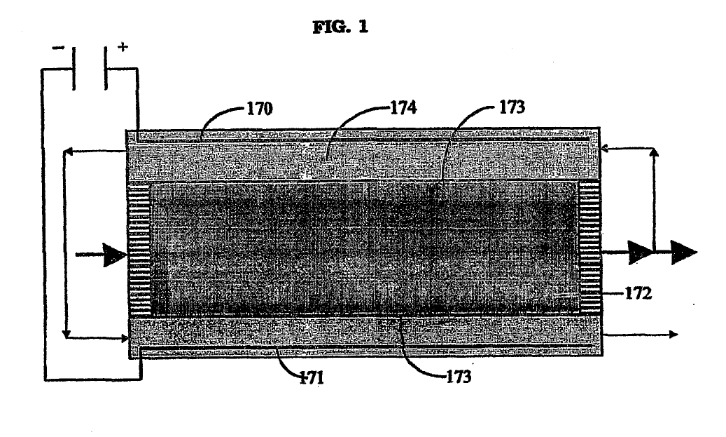

In one preferred embodiment for configuring an ion exchange unit in accordance with this invention, as schematically illustrated in FIG. 1, electrodes 170 and 171 are physically separated from the bulk of the ion exchange material 172 by means of an ion exchange membrane 173 of the same charge as that of the bulk material. The membrane 173 and the walls of the container form a compartment 174 in which the electrode 170 is contained and through which the previously measured sample flows to provide water for electrolysis and to sweep away gas bubbles generated by the electrode. It is preferred that the electrode be in contact with the cation exchange membrane 173, or that the compartment 174 be filled with an ion exchange material of the same charge as that of the membrane.

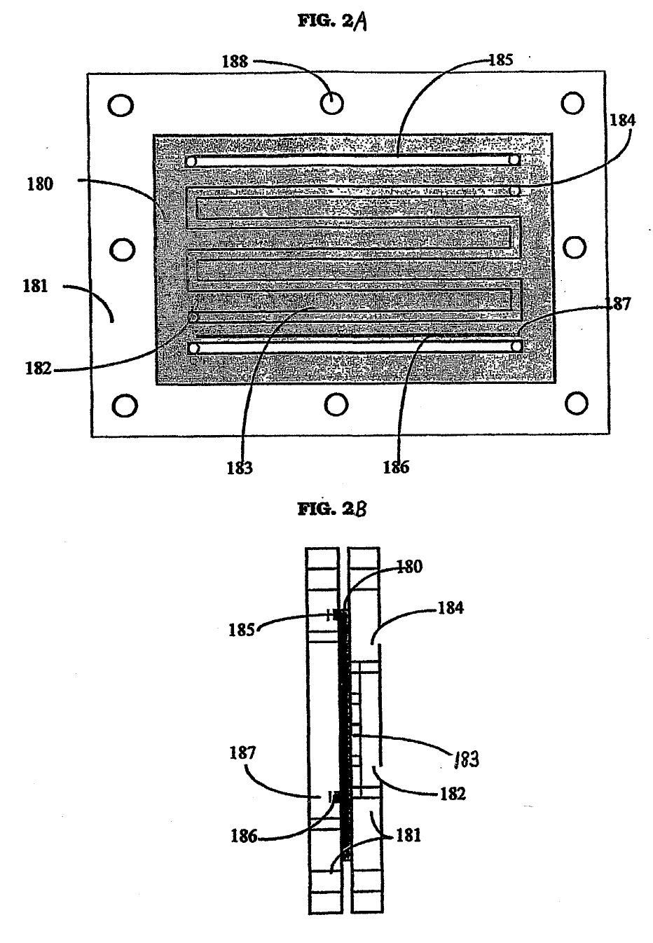

In another preferred embodiment for configuring an ion exchange unit in accordance with this invention, only an ion exchange membrane is used as the ion exchange material, as schematically illustrated in FIGS. 2A and 2B. In this case, a flat sheet of ion exchange membrane 180 is clamped between two electrically insulating plates 181 by means of bolts through holes 188 around the periphery of the plates. An inlet means 182 is provided for the sample stream which then flows in channels 183 contacting the ion exchange membrane 180 and through outlet means 184 to the conductivity meter. For the cation conductivity case, membrane 180 will be a cation exchange membrane, and the anode 185 will produce hydrogen ions by means of water electrolysis to continuously regenerate the membrane 180. These hydrogen ions migrate under the influence of a DC voltage through the membrane towards the cathode 186. Essentially all of the cations in the sample stream are exchanged with hydrogen ions from the membrane. These cations migrate through the membrane into the cathode channel stream and out to waste through outlet means 187. In this preferred embodiment, the overall direction of flow of the sample stream is counter current to the migration direction of the hydrogen ions. Also in this preferred embodiment, the anode and cathode channels are on the side of the membrane opposite from the sample stream channels. A corresponding description of the operation of an ion exchange unit as illustrated in FIGS. 2A and 2B would apply for the anion conductivity case.

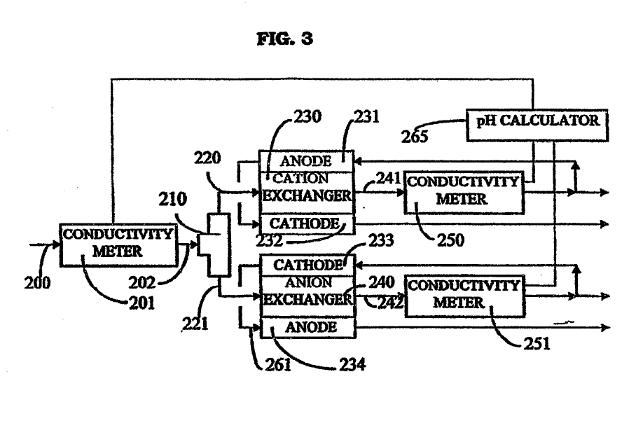

Referring to FIG. 3, one form of a continuous ionic monitoring system according to the present invention is schematically illustrated using two ion exchange units according to this invention in a parallel configuration. The system includes a sample fluid inlet 200 connected by a fluid conduit to a conductivity meter 201, which contains a mechanism for continuously measuring both the conductivity and the temperature of the sample stream. From the outlet of the said meter, the sample flows by means of a fluid conduit 202 into a stream divider 210, typically a T-junction or valve, which in turn is connected by means of fluid conduits 220 and 221 respectively to the inlet of a continuously regenerated cation exchanger vessel 230 according to this invention and to the inlet of a continuously regenerated anion exchanger vessel 240 according to this invention. In each exchanger vessel, electrodes 231 and 232 (vessel 230) and electrodes 233 and 234 (vessel 240), described below, are spaced apart with the respective cation or anion ion exchange materials disposed between them. The ion exchange materials may be in the form of beads, particles, fibers, screens, or membranes. As the cation conductivity sample portion passes by the cation exchange material, essentially all of the cations are absorbed by the cation exchange material and replaced by hydrogen ions. As the anion conductivity sample portion passes by the anion exchange material, essentially all of the anions are absorbed by the anion exchange material and replaced by hydroxyl ions. The respective treated sample portions flow out of the two exchangers and, by means of fluid conduits 241 and 242 respectively pass through conductivity meters 250 and 251 respectively, each containing a mechanism for continuously measuring both the conductivity and temperature of the respective treated sample stream portions. The electrical outputs from the conductivity meters are sent to a computing system 265 where the pH of the sample stream is automatically calculated from the continuously generated conductivity and temperature date.

A cation exchanger unit in accordance with the present invention can be constructed without an integral cathode, provided that an electric field is established across the unit utilizing the anode element of the unit, and provided that a waste stream flow path is provided along what would be the cathode side of the unit for removal of displaced cations. Similarly, an anion exchange unit in accordance with the present invention can be constructed without an integral anode.

Thus, in a variation of the embodiment of this invention as shown in FIG. 3, the cation exchanger unit and the anion exchanger unit can be consolidated into a single unit by eliminating the cathode element of the cation exchanger, eliminating the anode element of the anion exchanger, and positioning the cation exchanger compartment back-to-back with the anion exchanger compartment.

The sample pH may be calculated from the conductivity data generated according to this invention utilizing the following systems of equations:

k=conductivity at 25° C.

L=equivalent ionic conductivity at 25° C.

C=concentration

| subscripts | superscripts |
|---|---|
| H = hydrogen ion | S = specific |
| OH = hydroxyl ion | AC = anion conductivity |
| A = all other anions | CC = cation conductivity |
| M = all other cations | |

Equations

K^{S}=1/1000(C_{H}^{S}L_{H}+C_{A}^{S}L_{A}+C_{M}^{S}L_{M}+C_{OH}^{S}L_{OH})

k^{CC}=1/1000(C_{H}^{CC}L_{H}+C_{A}^{CC}L_{A}+C_{OH}^{CC}L_{OH})

k^{AC}=1/1000(C_{H}^{AC}L_{H}+C_{M}^{AC}L_{M}+C_{OH}^{AC}L_{OH})

Charge Balances:

C_{H}^{S}+C_{M}^{S}=C_{A}^{S}+C_{OH}^{S}

C_{H}^{CC}=C_{A}^{CC}+C_{OH}^{CC}

C_{OH}^{AC}=C_{H}^{AC}+C_{M}^{AC}

Because the anion concentration is unchanged by passage through a cation exchange column, and the cation concentration is unchanged by passage through an anion exchange column:

C_{A}^{CC}=C_{A}^{S}

C_{M}^{AC}=C_{M}^{S}

Because the hydrogen ions released are equal to the other cations absorbed by the resin:

C_{H}^{CC}=C_{H}^{S}+C_{M}^{S}

Because the hydroxyl ions released are equal to the other anions absorbed by the resin:

C_{OH}^{AC}=C_{A}^{S}+C_{OH}^{S}

The disassociation constant of water, K_{W}=C_{H}C_{OH} and −logK_{W}=−logC_{H}−logC_{OH}=14 at 25° C.

Computer programs are available to solve this system of equations for the salts of strong bases and strong acids to obtain the actual pH, or a very close approximation of the pH. If salts of weak bases and weak acids are present in the stream being tested, additional information collected from other analyses are needed for the calculation of the pH of the sample stream. For example, a Total Inorganic Carbon analyzer, as known in the art, can give the concentration of bicarbonate (a weak acid) present in the sample, thereby allowing calculation of the pH.

It will be apparent to those skilled in the art that other changes and modifications may be made in the above-described apparatus, processes and methods without departing from the scope of the invention herein, and it is intended that all matter contained in the above description shall be interpreted in an illustrative and not a limiting sense.

What is claimed is:

1. Apparatus for determining the ionic purity of an aqueous sample, said apparatus comprising:
a conductivity meter for measuring the conductivity and temperature of a sample;
a cation exchange element for exchanging cations present in a cation portion of said sample for hydrogen ions while said cation portion is passing in contact with said cation exchange element;
a conductivity meter for measuring the conductivity and temperature of said cation portion after contact with said cation exchange element;
a cation exchange element regeneration system for continuously regenerating said cation exchange element by displacing cations removed from said cation portion with new hydrogen ions generated by electrolysis of water;
an anion exchange clement for exchanging anions present in an anion portion of said sample for hydroxyl ions while said anion portion is passing in contact with said anion exchange element;
a conductivity meter for measuring the conductivity and temperature of said anion portion after contact with said anion exchange element; and,
an anion exchange element regeneration system for continuously regenerating said anion exchange element by displacing anions removed from said anion portion with new hydroxyl ions generated by electrolysis of water.

2. Apparatus according to claim 1 wherein said cation exchange element regeneration system comprises:
an anode compartment including an anode, an anode compartment inlet end, and an anode compartment outlet end;
a cathode compartment including a cathode, a cathode compartment inlet end, and a cathode compartment outlet end;
a direct current power source;
at least a cation exchange membrane disposed to form a cation membrane compartment, said cation membrane compartment having a cation membrane compartment inlet and a cation membrane compartment outlet; and,
a cation exchange material disposed in said cation membrane compartment.

3. Apparatus according to claim 1 wherein said anion exchange element regeneration system comprises:
an anode compartment including an anode, an anode compartment inlet end, and an anode compartment outlet end;
a cathode compartment including a cathode, a cathode compartment inlet end, and a cathode compartment outlet end;
a direct current power source;
at least an anion exchange membrane disposed to form an anion membrane compartment, said anion membrane compartment having an anion membrane compartment inlet and an anion membrane compartment outlet; and,
an anion exchange material disposed in said anion membrane compartment.

4. Apparatus according to claim 1 wherein said cation exchange element regeneration system further comprises:
two electrically insulating planar elements, a first of said planar elements comprising a fluid inlet and a fluid outlet pair and a sample stream channel disposed therebetween along one face thereof; a second of said planar elements comprising two fluid inlet and fluid outlet pairs, each having an electrode channel therebetween, along one face thereof;
an anode contained in one of said electrode channels and a cathode contained in the other of said electrode channels; and,
a cation exchange membrane disposed between said two planar elements, said membrane being in contact with said anode and said cathode along one surface of said membrane and being in contact with said sample stream channel along the opposite surface.

5. Apparatus according to claim 1 wherein said anion exchange element regeneration system further comprises:
two electrically insulating planar elements, a first of said planar elements comprising a fluid inlet and a fluid outlet pair and a sample stream channel disposed therebetween along one face thereof; a second of said planar elements comprising two fluid inlet and fluid outlet pairs, each having an electrode channel therebetween, along one face thereof;
an anode contained in one of said electrode channels and a cathode contained in the other of said electrode channels; and,
an anion exchange membrane disposed between said two planar elements, said membrane being in contact with said anode and said cathode along one surface of said membrane and being in contact with said sample stream channel along the opposite surface.

6. Apparatus according to claim 2 wherein said anode and said cathode compartments are filled with a cation exchange material.

7. Apparatus according to claim 3 wherein said anode and said cathode compartments are filled with an anion exchange material.

8. Apparatus according to claim 2 wherein said anode and said cathode are in contact with a cation exchange membrane.

9. Apparatus according to claim 3 wherein said anode and said cathode are in contact with an anion exchange membrane.

10. A system for measuring the ionic purity of a flowing aqueous sample, said system comprising:
a means of measuring the conductivity and temperature of a flowing sample stream;
a means of splitting said flowing sample stream into two substantially equal split sample streams;
a means for continuously exchanging cations for hydrogen ions in one of said split sample streams, and for continuously exchanging anions for hydroxyl ions in the other of said split sample streams;
a means of measuring both the conductivity and temperature of each of said split sample streams following said continuous ion exchange;
a means of calculating the pH of the sample stream using the temperature and conductivity of the original sample stream and of said two split ion-exchanged sample streams.

11. A method for determining the ionic purity of an aqueous sample, said method comprising the steps of:
measuring the conductivity and temperature of said sample;
continuously exchanging cations in a cation portion of said sample for hydrogen ions by contact with a cation exchange element;
continuously regenerating said cation exchange element with new hydrogen ions;
measuring the conductivity and temperature of said cation portion of said sample exiting from said contact with a cation exchange element;
continuously exchanging anions in an anion portion of said sample for hydroxyl ions by contact with an anion exchange element;
continuously regenerating said anion exchange element with new hydroxyl ions;
measuring the conductivity and temperature of said anion portion of said sample exiting from said contact with an anion exchange element; and,
calculating the ionic purity of the sample based on said conductivity and temperature measurements.

12. A method according to claim 11 wherein the exchanging of cations for hydrogen ions and the continuous regeneration of said cation exchange element is performed using:
an anode compartment means with an anode, an inlet end, and an outlet end;
a cathode compartment means with a cathode, an inlet end, and an outlet end;
a direct current power source;
two cation exchange membranes disposed to form a compartment between them, said compartment having an inlet means and an outlet means; and,
a cation exchange material disposed in said compartment between said membranes.

13. A method according to claim 11 wherein the exchanging of anions for hydroxyl ions and the continuous regeneration of said anion exchange element is performed using:
an anode compartment means with an anode, an inlet end, and an outlet end;
a cathode compartment means with a cathode, an inlet end, and an outlet end;
a direct current power source;
two anion exchange membranes disposed to form a compartment between them, said compartment having an inlet means and an outlet means; and,
an anion exchange material disposed in said compartment between said membranes.

14. A method according to claim 11 wherein the exchanging of cations for hydrogen ions and the continuous regeneration of said cation exchange element is performed using:
two electrically insulating plates; with one of said plates having an inlet, an outlet and a channel for the sample stream disposed between said inlet and out on one side of said plate; second said plate having an inlet, an outlet, and a channel between said inlet and outlet containing an anode, and having an inlet and outlet on the same side of said plate and a channel between said inlet and outlet containing a cathode; and,
a cation exchange membrane disposed between two said plates, having contact with said anode and said cathode on one side and contact with said sample stream channel on the opposite side.

15. A method according to claim 11 wherein the exchanging of anions for hydroxyl ions and the continuous regeneration of said anion exchange element is performed using:
two electrically insulating plates; with one of said plates having an inlet, an outlet and a channel for the sample stream disposed between said inlet and out on one side of said plate; second said plate having an inlet, an outlet, and a channel between said inlet and outlet containing an anode, and having an inlet and outlet on the same side of said plate and a channel between said inlet and outlet containing a cathode; and,
an anion exchange membrane disposed between two said plates, having contact with said anode and said cathode on one side and contact with said sample stream channel on the opposite side.

16. A method according to claim 12 wherein said anode and said cathode compartments are filled with a cation exchange material.

17. A method according to claim 13 wherein said anode and said cathode compartments are filled with an anion exchange material.

18. A method according to claim 12 wherein said anode and said cathode are in contact with a cation exchange membrane.

19. A method according to claim 13 wherein said anode and said cathode are in contact with an anion exchange membrane.

20. A method for measuring the ionic purity of an aqueous sample, said method comprising the steps of:
measuring the conductivity and temperature of a sample stream;
splitting said sample stream into two substantially equal split sample streams;
continuously exchanging cations for hydrogen ions in one of said split sample streams and continuously exchanging anions for hydroxyl ions in the other of said split sample streams;
measuring both the conductivity and temperature of each of said split sample streams following said continuous ion exchange; and,
calculating the pH of the sample stream using the temperature and conductivity of the original sample stream and of said two split ion-exchanged sample streams.

21. Apparatus for determining the cation conductivity of an aqueous sample, said apparatus comprising:
a cation exchange element for exchanging cations present in said sample for hydrogen ions while said sample is passing in contact with said cation exchange element;
a conductivity meter for measuring the conductivity and temperature of said sample after contact with said cation exchange element; and,
a cation exchange element regeneration system for continuously regenerating said cation exchange element by displacing cations removed from said cation portion with new hydrogen ions generated by electrolysis of water.

22. Apparatus according to claim 21 wherein said cation exchange element regeneration system comprises:
an anode compartment including an anode, an anode compartment inlet end, and an anode compartment outlet end;
a cathode compartment including a cathode, a cathode compartment inlet end, and a cathode compartment outlet end;
a direct current power source;
at least a cation exchange membrane disposed to form a cation membrane compartment, said cation membrane compartment having a cation membrane compartment inlet and a cation membrane compartment outlet; and,
a cation exchange material disposed in said cation membrane compartment.

23. Apparatus according to claim 22 wherein said anode and said cathode compartments are filled with a cation exchange material.

24. Apparatus according to claim 22 wherein said anode and said cathode are in contact with a cation exchange membrane.

25. Apparatus according to claim 21 wherein said cation exchange element regeneration system further comprises:
two electrically insulating planar elements, a first of said planar elements comprising a fluid inlet and a fluid outlet pair and a sample stream channel disposed therebetween along one face thereof; a second of said planar elements comprising two fluid inlet and fluid outlet pairs, each having an electrode channel therebetween, along one face thereof;
an anode contained in one of said electrode channels and a cathode contained in the other of said electrode channels; and,
a cation exchange membrane disposed between said two planar elements, said membrane being in contact with said anode and said cathode along one surface of said membrane and being in contact with said sample stream channel along the opposite surface.

26. Apparatus for determining the anion conductivity of an aqueous sample, said apparatus comprising:
an anion exchange element for exchanging anions present in said sample for hydroxyl ions while said sample is passing in contact with said anion exchange element;
a conductivity meter for measuring the conductivity and temperature of said sample after contact with said anion exchange element; and,
an anion exchange element regeneration system for continuously regenerating said anion exchange element by displacing anions removed from said anion portion with new hydroxyl ions generated by electrolysis of water.

27. Apparatus according to claim 26 wherein said anion exchange element regeneration system comprises:
an anode compartment including an anode, an anode compartment inlet end, and an anode compartment outlet end;
a cathode compartment including a cathode, a cathode compartment inlet end, and a cathode compartment outlet end;
a direct current power source;
at least an anion exchange membrane disposed to form an anion membrane compartment, said anion membrane compartment having an anion membrane compartment inlet and an anion membrane compartment outlet; and,
an anion exchange material disposed in said anion membrane compartment.

28. Apparatus according to claim 27 wherein said anode and said cathode compartments are filled with an anion exchange material.

29. Apparatus according to claim 27 wherein said anode and said cathode are in contact with an anion exchange membrane.

30. Apparatus according to claim 26 wherein said anion exchange element regeneration system further comprises:
two electrically insulating planar elements, a first of said planar elements comprising a fluid inlet and a fluid outlet pair and a sample stream channel disposed therebetween along one face thereof; a second of said planar elements comprising two fluid inlet and fluid outlet pairs, each having an electrode channel therebetween, along one face thereof;
an anode contained in one of said electrode channels and a cathode contained in the other of said electrode channels; and,
an anion exchange membrane disposed between said two planar elements, said membrane being in contact with said anode and said cathode along one surface of said membrane and being in contact with said sample stream channel along the opposite surface.

31. A method for determining the cation conductivity of an aqueous sample, said method comprising the steps of:
continuously exchanging cations in said sample for hydrogen ions by contact with a cation exchange element;
continuously regenerating said cation exchange element with new hydrogen ions; and,
measuring the conductivity and temperature of said sample exiting from said contact with a cation exchange element.

32. A method according to claim 31 wherein the exchanging of cations for hydrogen ions and the continuous regeneration of said cation exchange element is performed using:
an anode compartment means with an anode, an inlet end, and an outlet end;
a cathode compartment means with a cathode, an inlet end, and an outlet end;
a direct current power source;
two cation exchange membranes disposed to form a compartment between them, said compartment having an inlet means and an outlet means; and,
a cation exchange material disposed in said compartment between said membranes.

33. A method according to claim 31 wherein the exchanging of cations for hydrogen ions and the continuous regeneration of said cation exchange element is performed using:
two electrically insulating plates; with one of said plates having an inlet, an outlet and a channel for the sample stream disposed between said inlet and out on one side of said plate; second said plate having an inlet, an outlet, and a channel between said inlet and outlet containing an anode, and having an inlet and outlet on the same side of said plate and a channel between said inlet and outlet containing a cathode; and,
a cation exchange membrane disposed between two said plates, having contact with said anode and said cathode on one side and contact with said sample stream channel on the opposite side.

34. A method for determining the anion conductivity of an aqueous sample, said method comprising the steps of:
continuously exchanging anions in said sample for hydroxyl ions by contact with an anion exchange element;
continuously regenerating said anion exchange element with new hydroxyl ions; and,
measuring the conductivity and temperature of said anion portion of said sample exiting from said contact with an anion exchange element.

35. A method according to claim 34 wherein the exchanging of anions for hydroxyl ions and the continuous regeneration of said anion exchange element is performed using:
an anode compartment means with an anode, an inlet end, and an outlet end;
a cathode compartment means with a cathode, an inlet end, and an outlet end;
a direct current power source;
two anion exchange membranes disposed to form a compartment between them, said compartment having an inlet means and an outlet means; and,
an anion exchange material disposed in said compartment between said membranes.

36. A method according to claim 34 wherein the exchanging of anions for hydroxyl ions and the continuous regeneration of said anion exchange element is performed using:
two electrically insulating plates; with one of said plates having an inlet, an outlet and a channel for the sample stream disposed between said inlet and out on one side of said plate; second said plate having an inlet, an outlet, and a channel between said inlet and outlet containing an anode, and having an inlet and outlet on the same side of said plate and a channel between said inlet and outlet containing a cathode; and,
an anion exchange membrane disposed between two said plates, having contact with said anode and said cathode on one side and contact with said sample stream channel on the opposite side.
